(19) United States
(12) Patent Application Publication
(10) Pub. No.: US 2003/0149401 A1
(43) Pub. Date: Aug. 7, 2003

(54) Systems and methods for monitoring and controlling the temperature of an organ during surgery

(76) Inventors: Juan Ignacio Benetti Diaz De Brito, Rosario (AR); Sing-Fatt Chin, Fremont, CA (US)

Correspondence Address: BOZICEVIC, FIELD & FRANCIS LLP, 200 MIDDLEFIELD RD, SUITE 200, MENLO PARK, CA, 94025, US

(21) Appl. No.: 10/072,640

(22) Filed: Feb. 6, 2002

(51) Int. Cl. H05B 1/00

(52) U.S. Cl. 604/113

(57) ABSTRACT

Systems and methods are provided for monitoring and controlling the temperature of an organ during surgery, and are particularly useful for monitoring and controlling the temperature of the heart during surgery. The subject systems include a temperature sensor for application to the organ, reservoirs for containing temperature-controlled fluids to be delivered to the organ, a temperature regulator for regulating or maintaining the temperatures of such fluids, a pump for transferring the fluids from the reservoirs to the organ, a display for displaying certain system operating parameters and other information, a user interface module and a controller for controlling the functions of the system based on certain system operating parameters. The subject methods generally involve monitoring the temperature of an organ and, based on the organ's temperature, controlling the application of temperature-controlled fluids to the organ.

### FIELD OF THE INVENTION

The present invention is related to systems and methods for monitoring and controlling the temperature of an organ or an internal portion of the body during surgery.

### BACKGROUND OF THE INVENTION

During surgery it is often desirable or necessary to maintain an organ or a portion of the body at a certain temperature. For example, in open-heart surgery wherein cardiopulmonary bypass is employed, a cold solution having a temperature of about 4° C. is delivered under controlled conditions to the coronary arteries via the aortic root. The solution arrests the contractions of the heart through chemical action, supplies the heart muscle with oxygen and also cools the heart to a temperature typically in the range from about 10° to 14° C. in order to minimize deterioration of the heart muscle during the surgery. This cold solution includes cardioplegia which is a crystalloid chemical solution containing potassium and other additives. Depending on surgeon preference and the progress of the surgery, the solution may be comprised of 100% cardioplegia (“cold cardioplegia”) or some mixture of cardioplegia and blood (“warm cardioplegia”). The temperature and application of the cardioplegic solution is typically controlled by the heart-lung machine.

The maintenance of the heart's temperature at a certain prescribed temperature is also important in beating heart surgery as well. In beating heart surgery, the patient is not placed on cardiopulmonary bypass or administered cardioplegia. Instead, the heart is allowed to contract and pump blood throughout the surgery. As the heart is often exposed for extended periods to ambient conditions, the temperature of the heart tends to decrease as the surgery proceeds due to the low ambient temperature of the operating room. It is important to maintain the heart close to the body's natural temperature, i.e., 37° C., in order to maintain the hemodynamic stability of the heart. One way in which the surgical team attempts to maintain the temperature of the heart, is to monitor the heart's temperature and to apply a warm saline solution to the epicardial surface of the heart when the temperature drops below a certain temperature level. The monitoring of the heart's temperature is not continuous and the application of warm saline is not automatic, but are performed only when the physician or another member of the surgical team initiates such

Due to many of the drawbacks of temperature monitoring and temperature control and regulation of the heart during surgery, there is continued interest in the development of new devices and techniques for monitoring and controlling the temperature of organs during surgery. Of particular interest would be the development of systems and methods wherein the monitoring and controlling of an organ's temperature during surgery is continuous and automatic, thus obviating the need for physician intervention. It would be additionally beneficial if such system and method were applicable to both stopped and beating heart surgeries, and in both open and minimally invasive surgeries.

### SUMMARY OF THE INVENTION

The present invention provides systems and methods for monitoring and controlling the temperature of an organ during surgery. The subject systems generally include at least one temperature sensor configured for engagement with the organ for sensing the temperature of the organ, a means for selecting the temperature of the organ during the surgery and means for comparing the sensed organ temperature with the selected organ temperature. Various embodiments of temperature sensors may be employed with the subject systems, such as those that are in flush contact with a surface of the organ or have a probe-like configuration for penetrating the organ. The temperature selection function of the system preferably includes a keypad entry device operatively coupled to a microprocessor, a function of which is to compare the sensed organ temperature with the selected organ temperature.

The subject systems further include one or more sources of fluid and a means for independently regulating the temperature of the fluids. A mechanism is also provided for pumping the fluid from the at least one source of fluid to the organ. The pumping mechanism may further include a chamber for mixing two or more fluids from different sources or reservoirs. One or more fluid outlet conduits are provided which extend from the fluid sources and/or the pumping mechanism to the organ. Such outlet conduits may be configured for delivering fluid to either the interior or the exterior of the organ. The type of fluid employed may depend on the surgical operation at hand and, for cardiac surgery applications, may include saline, cardioplegia, blood or various mixtures of such which are regulated at various selected temperatures.

A particular embodiment of a subject system includes a temperature sensor configured for engagement with the organ for sensing the temperature of the organ; a temperature monitor for monitoring the sensed organ temperature; an interface module for selecting a desired temperature of the organ during surgery; means for comparing the monitored organ temperature with the desired organ temperature; at least one fluid reservoir containing a fluid; a fluid temperature regulator for regulating the temperature of the fluid; at least one fluid outlet conduit; and a pump for pumping the fluid from the at least one source of fluid through the at least one fluid outlet conduit.

The systems' functions of organ temperature sensing and monitoring, of comparing such to a selected temperature or range of temperatures, and of regulating and pumping fluids may be automatically performed or performed on demand by the user, and may be performed continuously, periodically or intermittently during the surgical procedure. Such functions may be programmed into the system by the user prior to commencing the surgery.

The subject methods of the present invention generally involve sensing the temperature of an organ during surgery and monitoring that temperature to ensure that it remains at an acceptable temperature or within an acceptable temperature range. A particular subject method includes using a subject system described above and, as such, engaging the temperature sensor with the organ, selecting an acceptable organ temperature or temperature range, sensing the temperature of the organ with the temperature sensor, comparing the sensed organ temperature with the selected organ temperature, regulating the temperature of the one or more fluids, and pumping one or more fluids from their respective sources or reservoirs to the organ when the sensed organ temperature is not at the selected organ temperature or within the selected temperature range. The acceptable organ temperature or temperature range is determined based on the surgical application being performed. Additionally, as mentioned above, the steps of sensing and monitoring the organ temperature, comparing the organ temperature with a selected temperature or temperature range, regulating the temperature of the fluids and pumping such fluids may be performed on continuous basis, periodically, intermittently or on demand by the user.

While the subject systems and methods may be used to monitor and control the temperature any kind of tissue structure or organ, they are particularly suited for use in monitoring and controlling the temperature of the heart during surgery.

These and other objects, advantages, and features of the invention will become apparent to those persons skilled in the art upon reading the details of the devices and methods of the present invention which are more fully described below.

### BRIEF DESCRIPTION OF THE DRAWINGS

FIG. 1 is a block diagram of an embodiment of a system of the present invention schematically illustrated in a cardiac application.

### DETAILED DESCRIPTION OF THE PREFERRED EMBODIMENTS

As summarized above, the present invention provides systems and methods for monitoring and controlling the temperature of an organ during surgery.

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

In further describing the present invention, an exemplary system will be described first, followed by a detailed description of the methods of the present invention, as well as a description of kits that include the subject systems for use in practicing the subject methods. While the present invention is described primarily in the context of cardiac applications, e.g., coronary artery bypass graft surgery and/or cardiac valve repair or replacement surgery, is not intended to be limiting, but exemplary of the structure and functions of the present invention. Those skilled in the relevant arts will appreciate that the subject systems, structurally modified as necessary, are suitable and useful for the monitoring and control of temperatures of other organs and tissue structures. Moreover, the subject systems and methods are suitable for open surgeries as well as minimally invasive surgeries. In the context of cardiac surgery, the subject systems and methods are suitable for on-pump, i.e., stopped heart, as well as off-pump, i.e., beating heart, surgeries.

### Systems of the Present Invention

As mentioned above, the subject systems are useful for monitoring and controlling the temperature of an organ during surgery. The subject systems are particularly useful for monitoring and controlling the temperature of the heart during surgery.

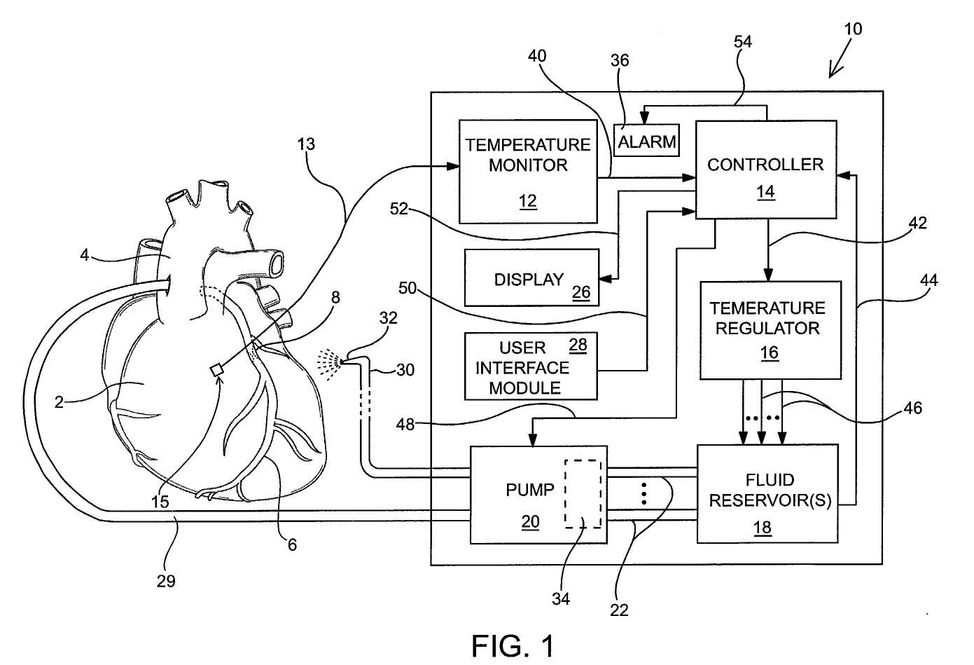

Referring to FIG. 1, there is shown a block diagram of a temperature monitoring and control system 10 of the present invention. System 10 includes a temperature sensing assembly including at least one temperature sensor 15 configured for physical engagement with the heart 2. Temperature sensing assembly may further include a temperature monitor 12 in communication with temperature sensor 15 and which can continuously receive temperature signals from sensor 15. An example of a suitable temperature sensor for use with the present invention is manufactured by Omega of Stanford, Conn., having Model P/N 5TC-TT-E-36-82. System 10 may employ any suitable communication modality between sensor 15 and monitor 12. For example, as illustrated in FIG. 1, sensor 15 may be electrically coupled by means of an insulated electrical conductor 13, e.g., cable or wire, to temperature monitor 12. Alternatively, temperature sensor 15 may be configured to transmit infrared signals representative of sensed temperatures to an infrared receiver housed within temperature monitor 12. Electrical conductor 13 and temperature sensor 15 are preferably made of biocompatible materials.

Additionally, temperature sensor 15 may have any suitable structural configuration for the particular application at hand. For example, temperature sensor 15 may have a surface area configured for flush contact with the surface of the organ being monitored. Such surface may be planar, curved, convex or concave. For example, sensor 15 may take the form of a flat disk having at least a portion, e.g., a flange material, which can be sutured to the surface the organ being monitored. Sensor 15 may also be an adhesive patch which is applied to the surface of the heart. Alternatively, sensor 15 may have an elongated or probe-like configuration for penetration or insertion into the organ. As such, such probe may include a puncturing member. The puncturing member may be a needle configured for insertion and placement in a chamber of the heart to sense the temperature therein. Alternatively, the puncturing member may be a hook for insertion into and securement to the myocardial tissue bed. In any of the above configurations, sensor 15 includes a thermocouple. For purposes of this description, a thermocouple may comprise any appropriate thermal sensing device for sensing the temperature of the tissue with which it is in contact or the organ chamber within which it is placed.

Temperature monitoring and control system 10 further includes one or more fluid reservoirs 18 within the housing of the system for holding fluids such as cardioplegia, saline, blood, blood-cardioplegia mixture, etc. For example, system 10 may include two reservoirs 18, one which contains a saline solution for application to the exterior of the heart, and one which contains a cardioplegic solution for perfusion into the coronary arteries. Another embodiment may provide one reservoir of cardioplegia and the other of blood, wherein the two fluids may be combined at selected ratios throughout the procedure. More than one reservoir 18 may include the same fluid, e.g., saline, at the same or different temperatures, e.g., warm saline and cold saline. More than two reservoirs may be provided. Reservoirs 18 may alternatively be provided externally of system 10.

Each reservoir 18 is in fluid communication with a pump mechanism 20 via one or more tubes or pipes 22. Pump 20 functions to pump the selected fluid from its reservoir 18 to an outlet apparatus which directs the fluid(s) to their respective intended locations. Depending on the type of pumping action desired for a particular application, any suitable type of pump 20 may be employed including, but not limited to, a peristaltic pump, a bellow pump, a gravity flow pump, a diaphragm pump, a centrifugal pump, a gear pump, a magnetic drive pump, a vacuum pump, etc. For example, a peristaltic pump may be advantageous for stopped heart applications in which cardioplegic solution is delivered to the veins and/or arteries. An example of a pump suitable for use with the present invention is the MasterFlex pump, having part number 77921-20, made by Barnant Company of Barrington, Ill.

Additionally, pump 20 may provide a mixing chamber 34 in which two or more fluids received from their respective fluid reservoirs 18 are combined together prior to being pumped to the heart. For example, during a stopped heart surgery, the physician may want to warm the cold cardioplegic solution being delivered from one reservoir 18 by mixing it with warm blood from a second reservoir 18. Moreover, as the surgery progresses and approaches its conclusion, the physician may desire to gradually change the ratio of cardioplegia to blood, e.g., decrease the amount of cardioplegia and increase the amount of blood.

System 10 further includes one or more biocompatible outlet conduits or tubes 29 or 30 fluidly coupled to and extending from pump 20 for transferring and directing the reserved fluids to the subject organ. Tubes 29 and 30 may be contiguous extensions of tubes 22, wherein pump 20 is caused to act upon the tubes to effect the desired pumping action. Outlet tubes 29 and 30 have appropriate sizes, lengths and configurations for the application at hand, and may be configured to have substantially low profiles so as not to interfere with the surgical area or with the activities of the surgical staff. More specifically, the size and configuration of each outlet conduit depends on the type of organ and the specific location on or within the organ to which a respective fluid is to be delivered. For example, for delivering fluid into the interior of a chamber of the heart or to the coronary arteries, which is commonly done in stopped heart applications, the outlet conduit is a cannula or catheter 29 which is positionable or deliverable within the aorta 4 of the heart 2 to the aortic root. As shown in FIG. 1, a cannula 29 is temporarily inserted through the wall of the ascending aorta 4 to deliver a cardioplegic solution or a chilled saline solution for antegrade cardioplegia delivery to the aortic root for drainage into the coronary arteries 6. A secondary catheter (not shown) may be used to deliver such fluid directly into the coronary sinus in a retrograde direction. Alternatively, a catheter (not shown) may be inserted percutaneously into the patient and delivered endovascularly to the heart. In other applications, it may be desirable to deliver the fluid to the exterior of the organ. For example, in beating heart surgery applications in which it may be necessary to warm the heart. As such, a warm saline solution may be delivered to the surface of the heart via outlet tubing 30. The distal end of outlet tubing 30 may be provided with a nozzle 32 for optimally directing the fluid to be delivered. Nozzle 32 may be configured to provide any suitable mode of dispersion of the fluid, e.g., spray, stream, mist, etc. System 10 may additionally provide a source of suction in communication with a suction tubing (not shown) for removing excess fluid, e.g., saline, and blood from the surgical area.

System 10 may further include a temperature regulator 16 by which the temperature of the fluid in each fluid reservoir 18 is independently regulated, monitored, maintained or changed via signal lines 46. Temperature regulator 16 may include one or more heat exchangers and coolants for regulating, maintaining and changing the temperatures of the respective fluids. Temperature regulator 16 may be AC-powered or battery-powered. The heat or coolant exchangers may be integral with reservoirs 18 or with tubes or pipes 22.

In certain embodiments of the present invention, the respective temperatures of the one or more fluids within the fluid reservoirs are continuously maintained at a constant temperature. For example, one fluid reservoir 18 may contain saline which is to be continuously maintained at body temperature for delivery to the surface of the heart, a second fluid reservoir 18 may contain cardioplegia which is to be continuously maintained at 4° C., while a third fluid reservoir 18 may contain blood which is also to be continuously maintained at body temperature. Such an embodiment is useful, for example, during a beating heart procedure in which it becomes necessary to convert to a stopped heart procedure. At such point in the procedure, the surgeon may want to use cold saline to assist in cooling the myocardium while the surgical staff preps the patient for connection to the heart-lung machine and for delivery of a cardioplegic and/or blood solution. In other embodiments, temperature regulator 16 is used to vary the temperatures of the respective fluids throughout the procedure. For example, based on a preprogrammed timing sequence or on-demand by the physician, a fluid, such as saline, in a single reservoir 18 which is initially maintained at a warm temperature, may be cooled at some point or points throughout the procedure. In other circumstances, for example during the course of a stopped heart procedure, it may be desirable to increase or decrease the temperature of the cardioplegia, blood or cardioplegia-blood solution.

System 10 may further include a display 26, such as a liquid crystal display, which receives electronic data via signal line 52 from a system controller 14, discussed in greater detail below. A suitable display unit for use with the present invention is made by Hantronix, Inc. of Cupertino, Calif., having part number HDM40416L-4. Display 26 may be used to display the current value of any parameter of system 10, including but not limited to the temperature of the heart as sensed by temperature sensor 15, the current and user-selected temperatures of the fluids within fluid reservoir 18, the speed and/or oscillation frequency (if applicable) of pump 20, the current volumes of the fluids within respective fluid reservoirs 18 and icons representing the type of fluid(s) currently being pumped. The display may further provide a visual alarm signal or icon for indicating when a parameter goes outside acceptable values, e.g., when the temperature of the heart goes above or below acceptable temperatures. Alternatively or additionally, an audio alarm 36 may be provided to notify the user under such circumstances.

System 10 may further provide a user interface module 28 such as in the form of keypad for entering or selecting relevant quantitative and qualitative information or data about the patient, the procedure or the system 10. Such relevant data may include but is not limited to the desired temperature at which the heart is to be maintained throughout the procedure, the type and volumes of the fluid(s) loaded within the reservoirs 18, the volume of the respective fluids to be dispensed at any one time or during a specified time interval, the temperature(s) at which the fluid(s) are to be regulated, warming-cooling timing sequences, the output tube to be employed, the speed of the pump, and the duration or cycle time of fluid delivery, etc.

System 10 further includes a controller 14 having means for receiving input signals from temperature monitor 12, user interface module 28 and fluid reservoir 18 via signal lines 40, 50 and 44, respectively. Such input signals include certain dynamic and static data. For example, such dynamic data may includes the actual or current organ temperature received from monitor 12 and the actual or current reserved fluid temperatures received from fluid reservoir 18. Such static data may data received from interface module 28 including, but not limited to, the desired or selected organ temperature and reserved fluid temperatures, and certain minimum and maximum performance values, e.g., low and high temperatures, for performing the functions of the subject methods, discussed in further detail below. Controller 14 may further include memory means for storing in such dynamic and static data and means for comparing the dynamic data to the static data in order to ensure, for example, that the actual temperature of the heart remains within acceptable range. Additionally, controller 14 further includes means for transmitting output signals to temperature regulator 16, pump 20, display 26 and alarm 36 via signal lines 42, 48, 52 and 54, respectively, in response to the input signals. Preferably, controller 14 includes a microprocessor for receiving, handling, storing, comparing and transmitting such data to control the system functions mentioned above as well as to control the timing of such functions.

The individual components of system 10, as described above, may be provided as discrete components or as an integral unit. For example, fluid reservoirs 18 and pump 20 may be provided as individual commercially available components, for example, in the form of intravenous saline bags and pumping devices, respectively, commonly available in hospital and clinical settings. Additionally, all or some of the electronic components of system 10, such as temperature monitor 12, controller 14, temperature regulator 16, display 26, user interface module 28 and alarm 36 may be provided as discrete electronic components.

Alternatively, system 10 may be completely integrated into a single unit or structure wherein fluid reservoirs 18 are fluidly isolated and sealed chambers in direct fluid communication with one or more pump mechanisms 20, both being electronically coupled to the electronic components of system 10, which themselves are integrated circuits having multiple circuit elements and/or semiconductor devices. Preferably, this integrated unit or structure has dimensions that make it portable and easy to handle and manage during a surgical procedure. While the integrated structure is reusable, certain components such as electrical conductor 13, temperature sensor 15, reservoirs 18 and output tubes 28 and 30 may be disposable.

### Methods of the Present Invention

As summarized above, the subject invention also includes methods for monitoring and controlling the temperature of an organ during surgery. With reference to FIG. 1, the subject methods will now be described in the context of heart surgery applications.

The subject methods generally involve sensing the temperature of the heart during the course of a surgical procedure, determining whether the sensed temperature is suitable, i.e., safe and/or efficacious, for the particular surgical application and, in response to such determination, delivering or applying a fluid to the heart, if necessary, wherein the fluid has a temperature selected to adjust or maintain, as the case may be, the temperature of the heart to or at a selected or desired temperature. The step of sensing the temperature of the heat may be done continuously or intermittently wherein intermittent sensing may be conducted at regular or irregular periodic intervals or on demand by the physician or user. The step of delivery or applying fluid to the heart may also be done continuously or intermittently wherein intermittent fluid delivery or application may be conducted at regular or irregular periodic intervals or on demand by the physician or user.

The selected temperature of the fluid may be the same as or different from the selected or desired temperature of the heart. The particular temperature range of the selected temperature of the heart will depend on the particular surgical application and the point in time during the surgical procedure. For example, when cooling of the heart is desired at the commencement of stopped heart procedures, the selected temperature of the solution (often comprised of 100% cardioplegia) is from about 2° to 6° C., and more typically about 4° C. When warming the heart at the end of a stopped heart procedures, the selected temperature of the solution (often comprised of a cardioplegia-blood combination or 100% blood) is from about 35° to 37° C., and more typically about 37° C. When maintaining the temperature of the heart during beating heart procedures, the selected temperature of the solution (often saline) is from about 35° to 37° C., and more typically about 37° C.

More specifically, the subject methods involve sensing the temperature of the heart and monitoring the sensed temperature of the heart by comparing it to a pre-selected or optimum temperature, such as the natural temperature of the body, 37° C., for beating heart applications, and 0° to 4° C. for stopped heart applications. The step of sensing the heart's temperature may be accomplished by providing one or more of the a subject temperature sensors of the kinds described above and applying or engaging each at a selected location within a chamber of the heart or within the myocardial tissue. The sensed temperature is provided to temperature monitor 12 via electrical conductor 13 which in turn is provided to controller 14 via input signal line 40. Controller 14 then compares the sensed temperature to a pre-selected (i.e., selected by the user) temperature stored in its memory.

The desired temperature of the heart, as well as other individual parameters, such as the desired initial or constant temperature of the fluid(s), fluid type and volume, pump speed, output tube to be used, fluid temperature regulation cycles, etc. may be pre-selected by a user by entering or keying in such information by means of interface module 28. These user inputs are sent to controller 14 via signal line 50. In other embodiments, a particular program may be selected by the user which automatically calibrates or sets controller 14 with a set of default parameters. For example, a program may be provided specifically for beating heart surgery, wherein the temperature of a saline solution held in a reservoir 18 may be maintained at about 37° C., but preferably no higher than 38° C. to effectively warm the heart to the desired temperature. As such, the minimum and maximum acceptable heart temperatures are set at about 35° C. and 37° C., respectively. Likewise, a stopped heart surgery program may be provided with given set of default parameters, wherein the temperature of a cardioplegic solution in a reservoir 18 is set at a temperature lower than about 0° C., often as low as 4° C., to effectively cool the heart to the desired temperature. As such, the minimum and maximum acceptable heart temperatures are set at about 2° C. and 6° C., respectively.

Certain embodiments of the present invention may allow for the user, via user interface module 28, to override a pre-selected parameter or program as may be required during the surgical procedure. For example, a complication may arise during the course of a beating heart procedure wherein the patient must be placed on cardiopulmonary bypass. Where as system 10 was initially programmed to a consistent spray of warm saline on the heart via outlet tubing 30 upon sensing that the heart had dropped below a selected minimum temperature, the physician may override such parameters and input a new set of parameters which are appropriate for the stopped heart procedure, e.g., cold cardioplegia is pumped with peristaltic pumping action to aorta 4 via cannula 29. Still other embodiments of the present invention may allow a user to input parameters as necessary throughout the procedure, e.g., “on demand,” rather than pre-selecting parameters prior to commencement of the surgical procedure.

The temperature of the fluid or fluids to be delivered or applied to the heart is regulated by temperature regulator 16 via signal lines 46. Controller 14 controls temperature regulator 16 via signal line 42 based on the input data received from temperature monitor 12 and user interface module 28. As such, the temperature of the fluid or fluids may be constantly maintained at a desired temperature. System 10 may be further configured such that a feedback signal 44, representative of the current fluid temperatures, is provided from each fluid reservoir 18 back to controller 14. In response to the feedback, controller 14 turns temperature regulator 16 on or off and/or directs it to apply heat or cold only when necessary so that the fluids do not become overheated or overcooled or are otherwise adjusted to compensate for a change in organ temperature. As such, the temperature of the fluid or fluids may be adjusted or changed throughout a surgery.

Through signal line 48, controller 14 also controls the function of pump 20, dictating when pump 20 is turned on or off, as well as whether two or more fluids from reservoirs 18 are to combined in mixing chamber 34 prior to being pumped to the heart. It may be desirable to refrain from pumping the fluids to the heart until the fluids have reached their desired temperature levels. As such, controller 14 may be programmed to initiate pump 20 only upon receiving a feedback temperature from reservoir 18 which indicates that the selected fluid(s) has reached its pre-selected temperature. Controller 14 may be further programmed to temporarily stop pump 20 upon receiving an override or on-demand input signal requiring a temperature change be made to one or more of the fluids, and then restart pump 20 upon the selected fluid achieving such override or on-demand temperature.

As mentioned above, controller 14 may be programmed to provide any system input or output data, whether static dynamic or static data, as desired by the user. The entirety of such data may be displayed continuously or certain data points may be displayed periodically or on demand by the user. Controller 14 may be further programmed to provide alarm signals when certain parameters, e.g., heart temperature, drift outside an acceptable range of values. Such alarm signals may be audio and/or visual, and sounded or displayed by alarm 36 and display 26 via signal lines 54 and 52, respectively. System 10 may be further configured to retain in its memory all static and dynamic data input or generated throughout a surgical procedure for later recall or to generated a report of such data.

### Kits

Also provided by the present invention are kits for use in practicing the subject methods. The subject kits include at least one subject system of the present invention, as described above. The subject kits may further include a plurality of the components of the subject systems which are disposable, such as the above described temperature sensor, outlet tubes and fluid reservoirs.

Additionally, the kits may include instructions for using the subject systems according to the subject methods. The instructions may be printed on a substrate, such as paper or plastic, etc. As such, the instructions may be present in the kits as a package insert, in the labeling of the container of the kit or components thereof (i.e., associated with the packaging or sub-packaging) etc. In other embodiments, the instructions are present as an electronic storage data file present on a suitable computer readable storage medium, e.g., CD-ROM, diskette, etc.

The subject invention is shown and described herein in what is considered to be the most practical, and preferred embodiments. It is recognized, however, that departures may be made there from, which are within the scope of the invention, and that obvious modifications will occur to one skilled in the art upon reading this disclosure.

The specific devices and methods disclosed are considered to be illustrative and not restrictive. Modifications that come within the meaning and range of equivalents of the disclosed concepts, such as those that would readily occur to one skilled in the relevant art, are intended to be included within the scope of the appended claims.

What is claimed is:

1. A system for monitoring and controlling the temperature of an organ or tissue area during surgery, comprising:
at least one temperature sensor configured for engagement with the organ for sensing the temperature of the organ;
means for selecting the temperature of said organ during said surgery;
means for comparing said sensed organ temperature with said selected organ temperature;
at least one source of fluid;
means for regulating the temperature of said at least one source of fluid; and
a mechanism for pumping said fluid from said at least one source of fluid to the organ, wherein the regulated temperature of said fluid is sufficient to bring the sensed temperature of the organ to the selected temperature of the organ.

2. The system of claim 1 further comprising at least one fluid outlet conduit extending from said at least one source of fluid to said organ.

3. The system of claim 2 wherein said at least one fluid outlet conduit is configured for delivering fluid to the interior of the organ.

4. The system of claim 2 wherein said at least one fluid outlet conduit is configured for delivering fluid to the exterior of the organ.

5. The system of claim 1 further comprising a display for displaying temperature data.

6. The system of claim 1 wherein said at least one temperature sensor is configured to be in flush contact with a surface of the organ.

7. The system of claim 6 wherein said at least one temperature sensor comprises a portion which is suturable to the surface of the organ.

8. The system of claim 6 wherein said at least one temperature sensor comprises an adhesive patch.

9. The system of claim 1 wherein said at least one temperature sensor comprises a probe-like configuration.

10. The system of claim 9 wherein said at least one temperature sensor has an organ penetration means.

11. The system of claim 1 wherein said means for selecting the temperature of said organ comprises a user keypad.

12. The system of claim 1 wherein said means for comparing said sensed organ temperature with said selected organ temperature comprises a microprocessor.

13. The system of claim 1 comprising a plurality of fluid sources.

14. The system of claim 13 wherein at least one fluid of said plurality of fluid sources comprises one of the group consisting of saline, cardioplegia and blood.

15. The system of claim 13 wherein the temperature of each said fluid is independently regulated.

16. The system of claim 1 wherein said fluid temperature regulating means comprises at least one of the group consisting of a heat exchanger and a coolant.

17. The system of claim 1 wherein said pumping mechanism comprises a peristaltic pump.

18. The system of claim 1 further comprising two or more sources of fluid, wherein said pumping mechanism comprises a chamber for mixing two or more fluids of said fluid sources.

19. The system of 1 wherein the speed and/or oscillation frequency of said pumping mechanism is variable.

20. The system of 1 further comprising an alarm in response to a sensed organ temperature which is outside an acceptable temperature range.

21. A system for monitoring and controlling the temperature of an organ or tissue area during surgery, comprising:
a temperature sensor configured for engagement with the organ for sensing the temperature of the organ;
a temperature monitor for monitoring the sensed organ temperature;
an interface module for selecting a desired temperature of the organ during surgery;
means for continuously comparing said monitored organ temperature with said desired organ temperature;
at least one fluid reservoir containing a fluid;
a fluid temperature regulator for regulating the temperature of said fluid;
at least one fluid outlet conduit; and
a pump for pumping said fluid from said at least one source of fluid through said at least one fluid outlet conduit.

22. The system of claim 21 comprising a first fluid reservoir containing a first fluid having a regulated temperature of about human body temperature and a second fluid reservoir containing a second fluid having a regulated temperature below human body temperature.

23. The system of claim 22 wherein said first fluid is of the group consisting of saline and blood.

24. The system of claim 22 wherein said second fluid is of the group consisting of saline, cardioplegia, blood and a cardioplegia-blood solution.

25. A method for monitoring and controlling the temperature of an organ or tissue area during surgery, comprising the steps of:
providing the system of claim 1;
engaging said temperature sensor with the organ;
selecting an acceptable organ temperature;
sensing the temperature of the organ;
comparing said sensed organ temperature with said selected organ temperature;
regulating the temperature of said at least one fluid; and
pumping said fluid from said at least one source of fluid to the organ when said sensed organ temperature is not at the selected organ temperature.

26. The method of claim 25 wherein said acceptable organ temperature comprises a temperature range.

27. The method of claim 25 wherein said acceptable organ temperature is determined based on the surgical application being performed.

28. The method of claim 25 wherein said step of sensing is performed continuously.

29. The method of claim 25 wherein said step of sensing is performed on demand.

30. The method of claim 25 wherein said step of comparing is performed continuously.

31. The method of claim 25 wherein said step of comparing is performed on demand.

32. The method of claim 25 wherein said step of regulating comprises the step of continuously maintaining the temperature of said at least one fluid.

33. The method of claim 25 wherein said step of regulating comprises the step of adjusting the temperature of said at least one fluid.

34. The method of claim 25 wherein the organ is the heart.

35. The method claim 25 wherein the surgery is performed on a stopped heart and said at least one fluid is cardioplegia.

36. The method of claim 35 wherein said cardioplegia is cold.

37. The method of claim 35 wherein said cardioplegia is warm.

38. The method of claim 25 wherein the surgery is performed on a beating heart and said at least one fluid is saline.

39. The method of claim 38 wherein said saline is warm.
